(19) United States
(12) Patent Application Publication
(10) Pub. No.: US 2014/0372427 A1
(43) Pub. Date: Dec. 18, 2014

(54) REAL-TIME ANALYTIC REPORT ANALYSIS AND RETRIEVAL FRAMEWORK

(71) Applicants: Doron Lehmann, Kfar Vradim (IL); Eyal Nathan, Tel Aviv (IL); Nimrod Barak, Tel Aviv (IL)

(72) Inventors: Doron Lehmann, Kfar Vradim (IL); Eyal Nathan, Tel Aviv (IL); Nimrod Barak, Tel Aviv (IL)

(73) Assignee: SAP PORTALS ISRAEL LTD, Ra anana (IL)

(21) Appl. No.: 13/916,857

(22) Filed: Jun. 13, 2013

(51) Int. Cl. G06F 17/30

(52) U.S. Cl. CPC G06F 17/30386
USPC 707/736

(57) ABSTRACT

The present disclosure describes methods, systems, and computer program products providing real-time analytic report analysis and data retrieval. One computer-implemented method includes receiving extracted metadata associated with a first analytic report, identifying the first analytic report using the received metadata, retrieving updated data used to generate the first analytic report, generating a second analytic report, where the second analytic report is an updated version of the first analytic report and uses the updated data, and transmitting the second analytic report.

### BACKGROUND

Various business/analytic applications can provide tools for generating analytic reports based on certain data. The generated analytic reports can be displayed, printed, copied, scanned, transferred, shared, and/or otherwise presented to one or more users. A time lag typically exists between the generation of an analytic report and the time that the analytic report is viewed/analyzed. In some instances, the data used for generating the analytic report changes during the time lag and the analytic report is already outdated when viewed. For example, a manager adds a graphical user interface snapshot of an inventory report graph into an analytic report for a presentation. By the time of the presentation, the data is no longer current. It may also be difficult to identify and locate source data that is used to generate analytic reports. This may be because the data is not persisted or is dynamically calculated, is stored on one or more systems, is generated by one or more applications not used to view the analytic reports, is presented in a an analytic report with no identification of the data or data source used to generate the analytic report, and the like. The inability to identify and locate the source data used to generate the analytic report results in the need to expend additional resources to locate and/or generate additional data necessary to create an updated analytic report.

### SUMMARY

The present disclosure relates to computer-implemented methods, computer-readable media, and computer systems for providing real-time analytic report analysis and data retrieval. One computer-implemented method includes receiving extracted metadata associated with a first analytic report, identifying the first analytic report using the received metadata, retrieving updated data used to generate the first analytic report, generating a second analytic report, where the second analytic report is an updated version of the first analytic report and uses the updated data, and transmitting the second analytic report.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, further comprising acquiring an image of the first analytic report.

A second aspect, combinable with any of the previous aspects, wherein the first analytic report image is received with the extracted metadata.

A third aspect, combinable with any of the previous aspects, further comprising analyzing the received metadata for sufficient analytic report identification markers.

A fourth aspect, combinable with any of the previous aspects, wherein the metadata is extracted from at least one of a machine-readable representation of data, a QR code, a bar code, a unique identifier, text, symbol, or image.

A fifth aspect, combinable with any of the previous aspects, further comprising overlaying the second analytic report and the first analytic report to provide a comparison of report associated data.

A sixth aspect, combinable with any of the previous aspects, further comprising providing analytic actions associated with the first analytic report or the second analytic report.

The subject matter described in this specification can be implemented in particular implementations so as to realize one or more of the following advantages. First, data used to generate an analytic report can be identified and retrieved by analyzing an image of the analytic report. The retrieved data can be used for various purposes, including generating an updated version of the analytic report. Second, a user reviewing an image of an analytic report can simultaneously view one or more updated versions of the analytic report to determine how data has changed over time. Third, different display modes (e.g., an overlay mode, a side-by-side mode, etc.) are provided and can be configured to present the original analytic report and the updated analytic report(s). Fourth, functionalities to further analyze and/or drill-down the original and/or the updated analytic report(s) are provided. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example distributed computing system for providing real-time analytic report analysis and data retrieval according to an implementation.

FIG. 2A is an illustration of an example analytic report image with an embedded QR code according to an implementation.

FIG. 2B is an illustration of an example analytic report image without an embedded QR code according to an implementation.

FIG. 3A is an illustration of an example presentation of images of an updated analytic report and an old analytic report with QR codes according to an implementation.

FIG. 3B is an illustration of an example presentation of images of an updated analytic report and an old analytic report without QR codes according to an implementation.

FIG. 4 is a flow chart illustrating a method for providing real-time analytic report analysis and data retrieval according to an implementation.

Like reference numbers and designations in the various drawings indicate like elements.

### DETAILED DESCRIPTION

This disclosure generally describes computer-implemented methods, computer-program products, and systems for providing real-time analytic report analysis and data retrieval. The following description is presented to enable any person skilled in the art to make and use the invention, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

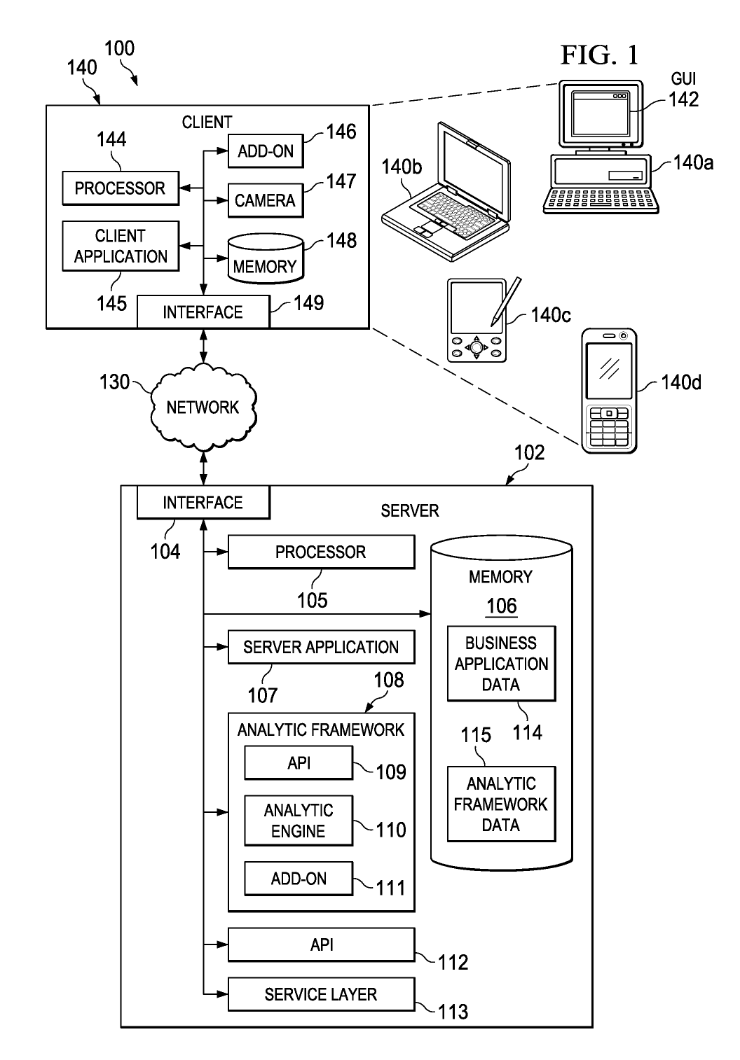

FIG. 1 is a block diagram illustrating an example distributed computing system (EDCS) 100 providing real-time analytic report analysis and data retrieval according to an implementation. The illustrated EDCS 100 includes or is communicably coupled with a server 102 and a client 140 that communicate across a network 130. At a high level, the server 102 is an electronic computing device operable to receive, transmit, process, store, or manage data and information associated with the EDCS 100. According to some implementations, server 102 may also include or be communicably coupled with an e-mail server, a web server, a caching server, a streaming data server, and/or other suitable server. The following described computer-implemented methods, computer-readable media, computer systems, and components of the example distributed computer system 100 provide real-time analytic report analysis and data retrieval from captured analytic report images. For example, the captured analytic report images could be obtained by using one or more client-device cameras and/or graphical user interface (GUI) “screenshot” functionality.

In general, the server 102 is a server that stores and/or executes one or more server applications 107 and/or analytic frameworks 108, and/or interacts with user requests and responses sent by clients 140 within and communicably coupled to the illustrated EDCS 100. In some implementations, the server 102 may be and/or include a web server, where the one or more server applications 107 and the analytic frameworks 108 represent one or more web-based application accessed and executed by the client 140 using the network 130 or directly at the server 102 to perform the programmed tasks or operations of a particular server application 107 and/or analytic framework 108. In some implementations, the server 102 may be and/or include a portal server, a business-intelligence server, and/or any other suitable server along with corresponding portal-based, business-intelligence-based, and/or other suitably-based applications 107 and/or analytic frameworks 108.

The server 102 is responsible for receiving requests using the network 130, for example data retrieval, analytic report generation/update, user authentication, configuration, and/or any other suitable requests from one or more client applications 145 (described below) associated with the client 140 of the EDCS 100 and responding to the received requests by processing said requests in one or more of a server application 107 and/or analytic framework 108. In addition to requests from the client 140, requests may also be sent to the server 102 from internal users, external or third-parties, other automated applications, as well as any other appropriate entities, individuals, systems, or computers. In some implementations, requests/responses can be sent directly to server 102 from a user accessing server 102 directly.

In some implementations, any and/or all components of the server 102, both hardware and/or software, may interface with each other and/or the interface using an application programming interface (API) 112 and/or a service layer 113. The API 112 may include specifications for routines, data structures, and object classes. The API 112 may be either computer-language independent or dependent and refer to a complete interface, a single function, or even a set of APIs. The service layer 113 provides software services to the EDCS 100. The functionality of the server 102 may be accessible for all service consumers using this service layer. Software services, such as those provided by the service layer 113, provide reusable, defined business functionalities through a defined interface. For example, the interface may be software written in JAVA, C++, or other suitable language providing data in extensible markup language (XML) format or other suitable format.

While illustrated as an integrated component of the server 102 in the EDCS 100, alternative implementations may illustrate the API 112 and/or the service layer 113 as stand-alone components in relation to other components of the EDCS 100. Moreover, any or all parts of the API 112 and/or the service layer 113 may be implemented as child or sub-modules of another software module, enterprise application, or hardware module without departing from the scope of this disclosure.

The server 102 includes an interface 104. Although illustrated as a single interface 104 in FIG. 1, two or more interfaces 104 may be used according to particular needs, desires, or particular implementations of the EDCS 100. The interface 104 is used by the server 102 for communicating with other systems in a distributed environment—including within the EDCS 100—connected to the network 130; for example, the client 140 as well as other systems communicably coupled to the network 130. Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated EDCS 100.

The server 102 includes a processor 105. Although illustrated as a single processor 105 in FIG. 1, two or more processors may be used according to particular needs, desires, or particular implementations of the EDCS 100. Generally, the processor 105 executes instructions and manipulates data to perform the operations of the server 102. Specifically, the processor 105 executes the functionality required to provide real-time analytic report analysis and data retrieval.

The server 102 also includes a memory 106 that holds data for the server 102, client 140, and/or other components of the EDCS 100. Although illustrated as a single memory 106 in FIG. 1, two or more memories may be used according to particular needs, desires, or particular implementations of the EDCS 100. While memory 106 is illustrated as an integral component of the server 102, in alternative implementations, memory 106 can be external to the server 102 and/or the EDCS 100. In some implementations, the memory 106 includes one or more instances of business application data 114 and/or analytic framework data 116.

The business application data 114 can include business/content objects and data, business processes, content provider locations, addresses, storage specifications, content lists, access requirements, or other suitable data. For example, for a database content provider, the business application data 114 may include a database server Internet Protocol (IP) address, URL, access permission requirements, data download speed specifications, etc. associated with the database content provider. The business/content object can be considered a representation of a business/non-business entity, such as an employee, a sales order, an invoice, an inventory report, a financial report, etc. The business/content object may encompass both functions, for example in the form of methods, and data, such as one or more properties. Business/content objects also form a point of entry of the functions and data of a system and enable the system to easily share, communicate, display, or otherwise operate with other systems. In some instances, a business/content object may be used to generate and/or update an analytic report.

The business application data 114 can be generated, stored, and/or converted from/into any suitable format or form, for example, binary, text, numerical, a database file, a flat file, or the like. In some implementations, the business application data 114 can directly accessed by any suitable component of the EDCS 100, for example, the server application 107, and/or the analytic framework 108. In some implementations, the business application data 114 may be updated regularly or at a particular time based on the underlying business process and/or content/content objects. While the business application data 114 is illustrated as an integral component of the memory 106, in alternative implementations, the business application data 114 can be external to the memory 106 (e.g., stored in memory 148) and/or be separated into both external business application data 114 and internal business application data 114 as long as accessible using network 130.

The analytic framework data 115 can include any suitable data that can be used by the analytic framework 118 and/or any other suitable component in the EDCS 100 for providing real-time analytic report analysis, data retrieval, and/or analytic report generation. For example, the analytic framework data 115 can include a database of content providers and/or business applications that are supported by the server 102, the client 140, and/or any other components in the EDCS 100. In some implementations, the analytic framework data 115 can include a metadata database or dictionary that can be used to find an analytic report and/or data used to generate a particular analytic report based on an identifier, metadata, and/or any other appropriate information. In some implementations, the analytic framework data 115 provides rules and functionalities to retrieve the original and/or up-to-date data used to generate the identified analytic report (e.g., by providing a link, an address, an index, or any other reference pointer). In some implementations, the analytic framework data 115 can contain/store, wholly or partially, data for the server application 107 and or other data sources (not illustrated) of the EDCS 100 used to generate an analytic report.

The analytic framework data 115 can be represented by any type of suitable data structure in any suitable format. For example, the analytic framework data 115 could be an executable module, spreadsheet, database, flat file, binary file, multi-part file, linked list, and/or the like. The analytic framework data 115 can be generated, stored, and/or converted from/into any suitable format or form. The analytic framework data 115 can be updated regularly or at a particular time triggered by a change of the metadata of an analytic report (for example, due to generation of an updated analytic report). In some implementations, multiple analytic framework datas 115 can be used to locate single and/or multiple analytic reports. The multiple analytic framework datas 115 may also provide functionality to retrieve original and/or up-to-date data used to generate single and/or multiple analytic reports.

The server application 107 is any type of application that allows the client 140 to request, view, add, edit, delete, and/or consume content on the client 140 obtained from the server 102, another client 140, and/or an additional business application (not illustrated) in response to a received request from the client 140. A server application can be considered a content provider that can include, for example, applications and data on a server and/or external services, business application, business application servers, databases, RSS feeds, document servers, web servers, streaming servers, caching servers, or other suitable content sources. In some implementations, a particular server application 107 can use business application data 114 to provide content to the client 140, generate an analytic report, or perform any other suitable operations for providing real-time analytic report analysis and data retrieval. In some instances, the server application 107 can further include an identifier (e.g., a QR code, a bar code, text, symbol, or image) in the generated analytic report, where the identifier can be used later to identify the analytic report and/or the data used to generate the analytic report.

Once a particular server application 107 is launched, a client 140 may interactively process a task, event, or other information associated with the server 102. The server application 107 can be any application, program, module, process, or other software that may execute, change, delete, generate, or otherwise manage information associated with a particular client 140. In some implementations, the server application 107 may be a business application, a portal application, a web-based application, and/or other suitable application consistent with this disclosure. The server application 107 can access the business application data 114 and/or the analytic framework data 116, and interface with the analytic framework 108 and/or other suitable component of the EDCS 100 to wholly or partially complete a particular task. For example, a particular server application 107 may receive a request for an analytic report from a client 140. The server application 107 can access the business application 114 and generate an analytic report as requested.

Additionally or differently, a particular server application 107 may operate in response to and in connection with at least one request received from other server application 107, other components (e.g., software and/or hardware modules) associated with another server 102, and/or other components of the EDCS 100. In some implementations, the server application 107 can be and/or include a web browser. In some implementations, each server application 107 can represent a network-based application accessed and executed using the network 130 (e.g., through the Internet, or using at least one cloud-based service associated with the server application 107). For example, a portion of a particular server application 107 may be a web service associated with the server application 107 that is remotely called, while another portion of the server application 107 may be an interface object or agent bundled for processing at a remote client 140. Moreover, any or all of a particular server application 107 may be a child or sub-module of another software module or enterprise application (not illustrated) without departing from the scope of this disclosure. Still further, portions of the particular server application 107 may be executed or accessed by a user working directly at the server 102, as well as remotely at a corresponding client 140. In some implementations, the server 102 or any suitable component of server 102 or the EDCS 100 can execute the server application 107.

The analytic framework 108 is an infrastructure supporting client-side and/or server-side real-time analytic report analysis and data retrieval services. For example, the analytic framework 108 is responsible for storing analytic-report data and/or generating/communicating content (e.g., an updated version of an analytic report) to a client 140 device according to a user request and/or a configuration that may be defined for the client 140 device. The analytic framework 108 also provides a server-side framework with business logic and functionality to access the memory 106 in order to use the business application data 114 and/or the analytic framework data 116. While the server 102 is illustrated as containing a single analytic framework 108, alternative implementations of server 102 may include any number of analytic frameworks 108 in any suitable configuration. In some implementations, there may be one or more other analytic frameworks located in other components of the EDCS.

In some implementations, the analytic framework 108 can include an API 109, an analytic engine 110, and/or an add-on 111. In some implementations, the API 109, the analytic engine 110, and/or the add-on 111 can perform real-time analytic report analysis and data retrieval in a sequential, parallel, and/or other suitable manner.

The API 109 can act as an interface between a client application 145 and the analytic framework 108. In some implementations, the API 109 can be similar to the API 112 but performing functions particular to the analytic framework 108. The API 109 may also include specifications for routines, data structures, and object classes. In some implementations, the API 109 may be either computer-language independent or dependent and refer to a complete interface, a single function, or even a set of APIs. In some implementations, the API 109 can receive a client request to provide an up-to-date analytic report, and/or receive a captured image and/or metadata of an analytic report from the client 140. In some implementations, the API 109 can inform the analytic engine 110 about the client request, pass the captured image and/or metadata to the analytic engine 110, receive an updated analytic report from the analytic engine 110, and/or prepare the updated analytic report suitable for the client application 145. In some implementations, the API 109 can receive a request from the server application 107 (or other suitable application/process) to store analytic report data associated with a generated analytic report. The API 109 can also perform additional or different operations that are consistent with this disclosure.

Although illustrated as integral to analytic framework 109, in some implementations, the API 109 can be part of the API 112, or stand-alone. In some implementations, the API 109 can be incorporated entirely or in part into any component of the EDCS 100 including the interface 104 and the server application 107.

The analytic engine 110 can be any application, program, module, process, or other software that may store, execute, analyze, change, delete, generate, or otherwise manage information associated with an analytic report. Specifically, the analytic engine 110 is an application providing functionality for analyzing a captured image and/or image data (e.g., metadata) of an analytic report, retrieving up-to-date data of the analytic report following analysis of the metadata of the analytic report, and managing the generation of the updated analytic report.

In some implementations, the analytic engine 110 can perform any suitable image analysis technique and/or matching algorithm for obtaining suitable information to identify the analytic report associated with the image and the data used to generate the analytic report. For example, the analytic engine 110 can include optical analysis software to extract metadata from an image. In some examples, the analytic engine 110 can apply optical character recognition (OCR) techniques for identifying metadata (e.g., a title, axis labels, legends, codes, values, labels, time and date, version, etc.), execute graphical-pattern-recognition algorithms to identify analytic report visualizations (e.g. bar chart, pie chart, etc.), and/or other suitable methods to extract metadata from an image associated with an analytic report. In some implementations, the analytic engine 110 may recognize a machine-readable representation of data (e.g., a QR code, a bar code, a unique identifier, text, symbol, or image) associated with the analytic report image. The machine-readable representation of data can be a unique identifier that may already include or be mapped to the metadata particular to the analytic report.

In some implementations, the analytic engine 110 retrieves the up-to-date data of the analytic report by searching for a matching analytic report in the analytic framework data 116 and, for example, retrieving the corresponding up-to-date data in the business application data 114 of the server 102. In some other implementations, the analytic engine 110 may retrieve the data from another sever 102, and/or any other components of the EDCS 100 communicably linked via network 130. In some implementations, based on the retrieved up-to-date data, the analytic engine 110 and/or the server application 107 can generate an updated analytic report and transmit the updated analytic report to the client 140 for display on the GUI 142.

In some implementations, the analytic engine 110 can also perform other processing of the received image/image data from the client 140. For example, the analytic engine 110 may perform authentication of the client 140 to determine whether the client 140 is authorized to access and retrieve the analytic report data in the server 102. In some implementations, the analytic engine 110 can provide means for supporting the client 140 to perform analytic actions on the analytic report. The analytic action can include, for example, drilling down in the report data, changing scope (e.g. watching data over longer periods of time, different regions, etc.), and/or any other suitable actions.

The add-on 111 can be any type of plug-in, extension, and/or any other appropriate type of software module that can be used, for example, to provide the analytic framework 108 and/or the server application 107 with additional/enhanced functionality. For instance, the add-on 111 can provide functionality to the server application 107 to automatically generate, submit, embed, or otherwise include analytic report metadata in an analytic report when the analytic report is generated and/or updated. Another example could include the automatic storage of analytic report metadata associated with a generated analytic report by the server application 107 once the analytic report is generated. The add-on 111 can also serve to instruct the server application 107 (and/or other suitable application) what analytic report metadata is required to be stored following generation of an analytic report. In some implementations, the add-on 111 can serve to convey metadata between the server application 107 and one or more components of the analytic framework 108, and/or the analytic framework data 116. In some instances, the add-on 111 can serve as an interface with one or more other analytic frameworks 108 associated with server 102 or any other server 102 in the EDCS 100. For example, the add-on 111 can receive and submit instructions from one or more other analytic frameworks 108 and/or coordinate the one or more other analytic frameworks 108 in identifying and retrieving data/report in an individual and/or collective manner.

In some implementations, some or all functionalities associated with the add-on 111 can be implemented by the analytic engine 110 and/or vice versa. In some implementations, the add-on 111 could be configured to be an integral part of the analytic engine 110 wholly or in part. In some instances, the add-on 111 can work with add-on 146 of the client 140 to provide additional/enhanced functionality for real-time analytic report analysis and data retrieval.

In some implementations, one or more components of the analytic framework 108 can provide functionality operable to analyze a received analytic report image from the client 140, analyze, and extract report-associated metadata from the analytic report image. In these instances, the analytic framework 108 can operate to verify analytic-report-associated metadata transmitted to the analytic framework 108. The analytic framework 108 can also perform a self-analysis if the data received from the client 140 is detected to be incomplete, in error, and/or otherwise insufficient to identify an analytic report. In this instance, the analytic framework 108 can execute similar and/or additional applications not available on the client 140 to analyze the analytic report image to extract necessary metadata.

The client 140 (e.g., 140a-140d) may be any computing device operable to connect to or communicate with at least the server 102 using the network 130. In general, the client 140 comprises an electronic computing device operable to receive, transmit, process, and store any appropriate data associated with the EDCS 100. Typically the client 140 can process code generated by, for example, client application executables, GUIs, utilities/tools, and the like. The client typically includes a processor 144, a client application 145, an add-on 146, a camera 147, a memory 148, and/or an interface 149.

The client application 145 is any type of application that allows the client 140 to navigate to/from, request, view, edit, delete, and or manipulate content on the client 140, for example content from a server business application 107. In some implementations, the client application 145 can be and/or include a web browser. In some implementations, the client application 145 can use parameters, metadata, and other information received at launch to access a particular set of data from the server 102 and/or other components of the EDCS 100. Once a particular client application 145 is launched, a user may interactively process a task, event, or other information associated with the server 102 and/or other components of the EDCS 100. For example, the client application 145 may request an analytic report from server 102, and/or receive an analytic report from the server 102. In some instances, the client application 145 may present, edit, delete, or otherwise manipulate an analytic report generated by the server application 107. In some instances, a particular client application 145 may generate an analytic report based on information received from the server 102. In some implementations, the client application 145 may act as a GUI interface for the server application 107, other components of server 102, and/or other components of the EDCS 100. Further, although illustrated as a single client application 145, the client application 145 may be implemented as multiple client applications in the client 140.

The add-on 146 can be any type of plug-in, extension, and/or any other appropriate type of software module that can be used, for example, to provide the client application 145 with additional/enhanced functionality. For instance, the add-on 146 might provide buttons or menus/options to “generate updated report” of an existing report presented by the client application 145. The add-on 146 may provide buttons or menus/options to prompt a user to input user preferences, receive user inputs, process and/or submit the user preferences to configure the real-time analytic report analysis and data retrieval service. In some implementations, the add-on 146 can be similar to the add-on 111 but providing functionality particular to the client 140.

In some implementations, the add-on 146 can interact with the user interface 142, the camera 147, other components of server 102, and/or other components of the EDCS 100 to capture an image of an analytic report, analyze the image, extract metadata from an image, and/or transmit the image/metadata to the server 102 over the interface 149. As an example, the add-on 146 may interface with the user interface 142 to capture an image of an analytic report (e.g., a screenshot of the analytic report, or a picture taken by a camera). In some implementations, the add-on 146 may include optical analysis software that can extract metadata from an image. The add-on 146 may provide additional or different functionalities. In some implementations, the add-on 146 on the client 140 can perform some or all functionalities of the analytic framework 108 and/or the server application at the server 102. In some implementations, the add-on 146 could be part of the client application entirely or in part.

The camera 147 is operable to capture image external to client 140. In some implementations, camera 147 can use a lens assembly to focus light onto an electronic image sensor and digitally record image information into memory 148 in various digital file formats. For example, digital file formats used to record the image information may include JPG, GIF, BMP, TIFF, PNG, AVI, DV, MPEG, MOV, WMV, RAW, and/or other suitable digital file formats. In some implementations, the electronic image sensor can be a charge coupled device (CCD), an active pixel sensor (CMOS), or other suitable electronic image sensor. Camera 147 may provide a live preview of the external image source to be photographed. Camera 147 may also provide optical and/or digital zoom functionality and panoramic images in both two and three dimensions. In other implementations, the recorded image information can be both still and video with sound.

Camera 147 can capture image data of one or more analytic reports external to the client 140. For example, the camera 147 may take a picture of an analytic report (e.g., a presentation slide, a poster, an advertisement, a hard-copy report, etc.), scan a machine-readable representation of data (e.g., a QR code, a bar code, a unique identifier, text, symbol, or image, etc.) attached with an analytic report, or otherwise capture an image of an analytic report.

In some implementations, image data recorded by camera 147 may be stored in memory 148, transferred over network 130 to the server 102, or a remote data storage location (not illustrated). Although illustrated as integral to client 140, camera 147 may also be physically or communicably connected to client 140. For example, camera 147 may be inserted into or connected to (e.g., by a cable, wireless connection, etc.) an interface port (not illustrated) on client 140. While the client 140 is illustrated as containing a single camera 147, alternative implementations of client 140 may include any number of cameras 149 in any orientation/configuration suitable to the purposes of the EDCS and particularly the requirements to provide real-time analytic report analysis and data retrieval.

The interface 149 is used by the client 140 for communicating with other computing systems in a distributed computing system environment, including within the EDCS 100, using network 130. For example, the client 140 uses the interface to communicate with the server 102 as well as other systems (not illustrated) that can be communicably coupled to the network 130. The interface 149 may be consistent with the above-described interface 104 of the server 102 or other interfaces within the EDCS 100. The processor 144 may be consistent with the above-described processor 105 of the server 102 or other processors within the EDCS 100. Specifically, the processor 144 executes instructions and manipulates data to perform the operations of the client 140, including the functionality required to send requests to the server 102 and to receive and process responses from the server 102.

The memory 148 typically stores objects and/or data associated with the purposes of the client 140 but may also be consistent with the above-described memory 106 of the server 102 or other memories within the EDCS 100 and be used to store data similar to that stored in the other memories of the EDCS 100 for purposes such as backup, caching, and the like.

Further, the illustrated client 140 includes a GUI 142. The GUI 142 interfaces with at least a portion of the EDCS 100 for any suitable purpose. For example, the GUI 142 may be used to view data associated with the client 140, the server 102, or any other component of the EDCS 100. In particular, the GUI 142 can be used to view and navigate various analytic reports located both internally and externally to the client 140. In some implementations, a request to generate and/or update an analytical report can be performed using a GUI 142 accessible to a user on a particular client 140. In some implementations, the GUI 142 can be used to present a visualization of an analytic report and overlay another analytic report over an existing report to show the difference between the two reports.

There may be any number of clients 140 associated with, or external to, the EDCS 100. For example, while the illustrated EDCS 100 includes one client 140 communicably coupled to the server 102 using network 130, alternative implementations of the EDCS 100 may include any number of clients 140 suitable to the purposes of the EDCS 100. Additionally, there may also be one or more additional clients 140 external to the illustrated portion of the EDCS 100 that are capable of interacting with the EDCS 100 using the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the server 102 or the client 140 itself, including digital data, visual and/or audio information, or a GUI 142, as shown with respect to the client 140.

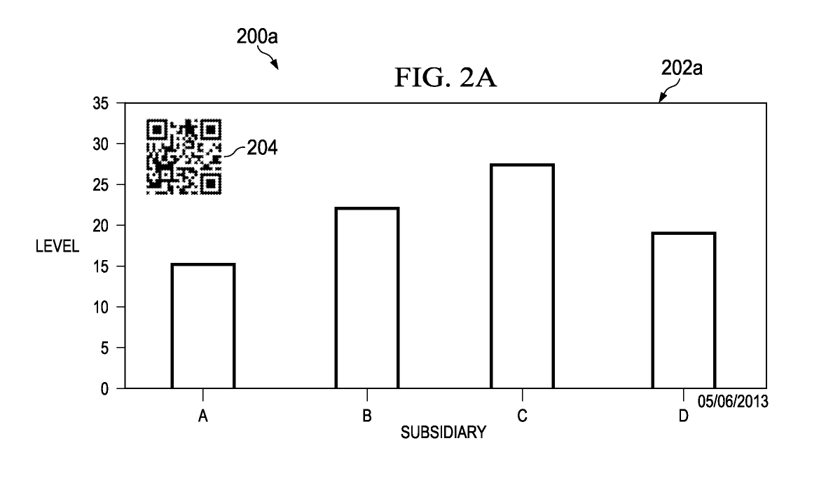

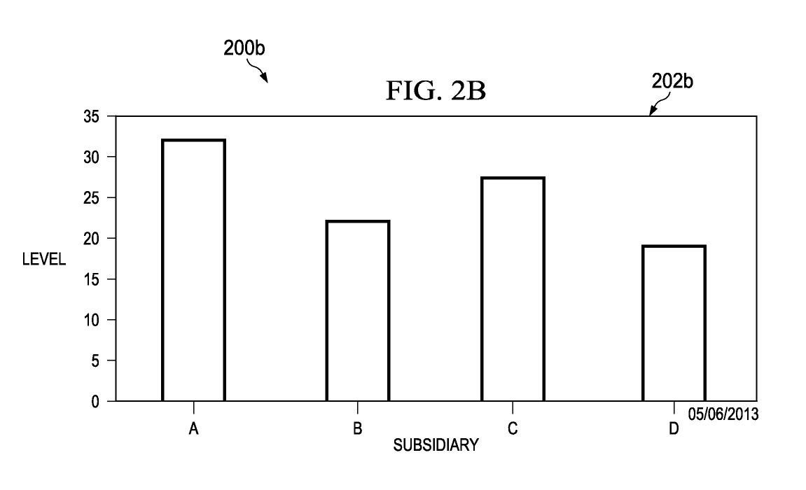

FIG. 2A is an illustration 200a of an example analytic report 202a image with an embedded QR code 204 according to an implementation. The example analytic report 202a shows inventory levels for each of four subsidiaries (A, B, C and D) as of May 6, 2013. The embedded QR code 204 can encode metadata associated with the analytic report 202a. The metadata can include, for example, a title, axis labels, legends, codes, values, labels, time and date, version, and/or any other suitable information particular to the analytic report 205a and/or a source that generated the analytic report 202a. In some implementations, other machine-readable representations of data (e.g., a bar code or other digital code, a unique identifier, text, symbol, image, etc.) can be used to encode the metadata and be embedded in the analytic report.

The image of the example analytic report 205a can be obtained, for example, by screenshot, a camera(s) 147 or other image processing device, and/or other suitable means. The image can be displayed on a GUI of a client 140 (e.g., GUI 142 as illustrated in FIG. 1). In some implementations, the client can scan the QR code 204, decode/retrieve the metadata encoded in the QR code 204, and send the metadata to the above-described analytic framework 108 for further processing (for example, identifying the particular data and/or application(s) used to generate the analytic report).

FIG. 2B is an illustration 200b of an example analytic report 202b image without a QR code according to an implementation. In this instance, the example analytic report 202b is the same as the example analytic report 202a as shown in FIG. 2A except without an embedded QR code 204. The client can perform any suitable image analysis technique to extract metadata from the image of the example analytic report 202b. For example, the client can apply OCR techniques for identifying applicable metadata to identify/describe the report (e.g., a title, axis labels, legends, codes, values, labels, time and date, version, etc.), execute graphical-pattern-recognition algorithms to identify types of analytic report visualizations (e.g. bar chart, pie chart, color, etc.) and associated data, and/or other suitable methods. The extracted metadata can be passed to the analytic framework 108 for further processing.

In some implementations, the extracted metadata, either decoded from the QR code 204 or extracted from the image of the analytic report 202a/b, can be sent together with an image (or a portion of the image) of the analytic report 202a/b to the analytic framework 108. In some other implementations, the client can simply send the image of the analytic report 202a/b (or a portion of the image) to the analytic framework 108 without analyzing the image for metadata. In this instance, the analytic framework 108 and/or other component of server 102 can analyze and/or extract metadata from the received image as appropriate.

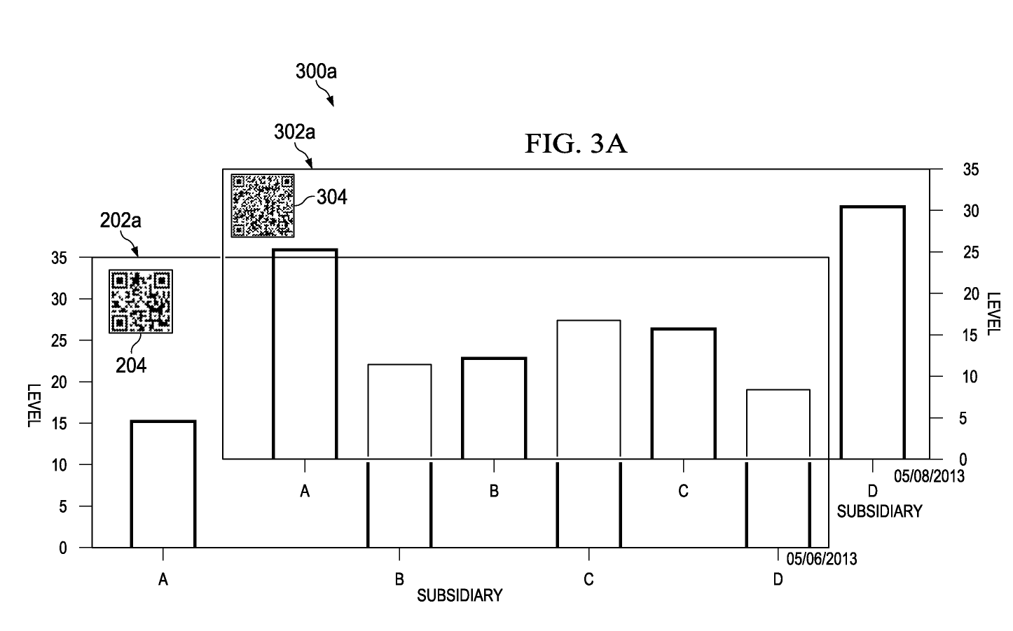

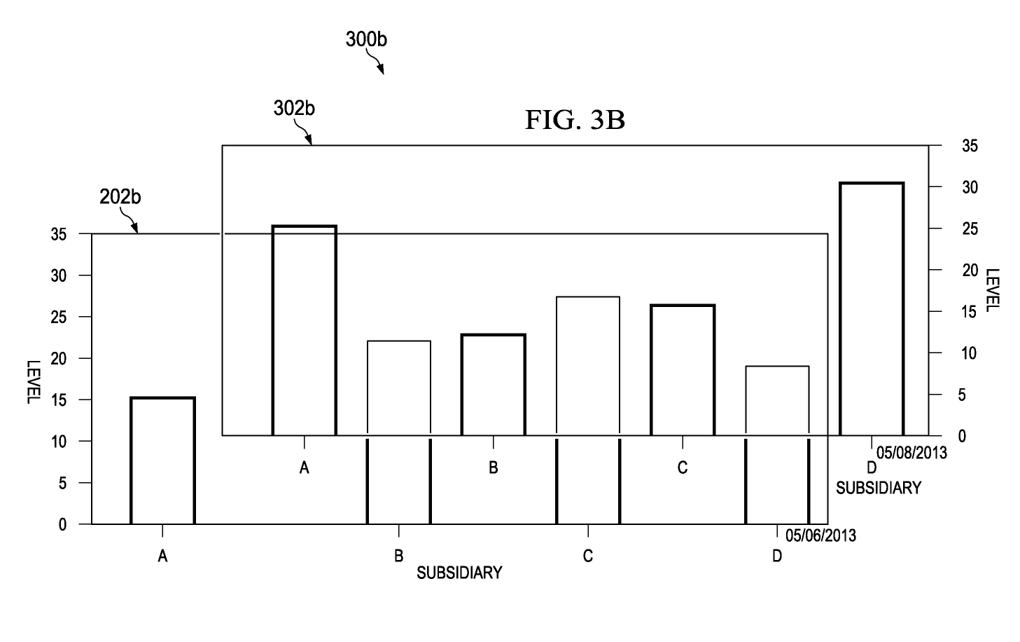

FIG. 3A is an illustration of an example presentation 300a of images of an updated analytic report 302a and an old analytic report 202a with QR codes according to an implementation. The old analytic report 202a is the same as the example analytic report 202a as shown in FIG. 2A. The updated analytic report 302a shows updated inventory levels for the four subsidiaries (A, B, C and D) as of May 8, 2013. The updated analytic report 302a has an embedded QR code 304 with information particular to the updated analytic report 302a, while the old analytic report 202a has the same QR code 204 as shown in FIG. 2A.

Any suitable operation described with respect to FIG. 2A can be performed with respect to the updated analytic report 302a and/or an old analytic report 202a in FIG. 3. In some implementations, additional or alternative operations can be conducted. For example, the client can choose and/or change the display mode (e.g., an overlay mode, a side-by-side mode, or any other appropriate display mode) for the two analytic reports 202a and 302a. Specifically, the client can choose to switch positions of the two analytic reports, hide either report, delete either report, move report(s), change size, range, resolution, orientation, transparency level, or any other appropriate attribute of either report, and/or perform any other suitable operation. In some implementations, the client and/or the application that generates the analytic reports can provide functionalities to automatically calculate, analyze, display, and/or highlight differences between the updated analytic report 302a and the old analytic report 202a. In some implementations, more than two analytic reports can be generated and displayed simultaneously. For example, multiple analytic reports can be generated, updated, and/or displayed over a certain amount of time such that changes or evolution of data can be observed.

In some implementations, one or more of components of the updated analytic report 302a and/or the old analytic report 202a are selectable. For example, the client can select the inventory level of subsidiary A of the updated analytic report 302a for further analysis. Additional/detailed information particular to the inventory level of subsidiary A may be prompted, enlarged, or otherwise presented upon the selection. In some implementations, the client can analyze either one of the analytic reports and request for a newer update based on either one of the analytic reports. In some implementations, the client can perform additional or different operations to drill-down into data presented on any analytic report.

FIG. 3B is an illustration 300b of an example presentation of images of an updated analytic report 302b and an old analytic report 202b without QR codes according to an implementation. The updated analytic report 302b is the same as the analytic report 302a except without the QR code 304, while the old analytic report 302b is the same as the old analytic report 202a except without the QR codes 204/304, respectively. Any suitable operation described with respect to FIGS. 2A, 2B, and 3A can be applied to the analytic report 302b and/or the analytic report 315b accordingly.

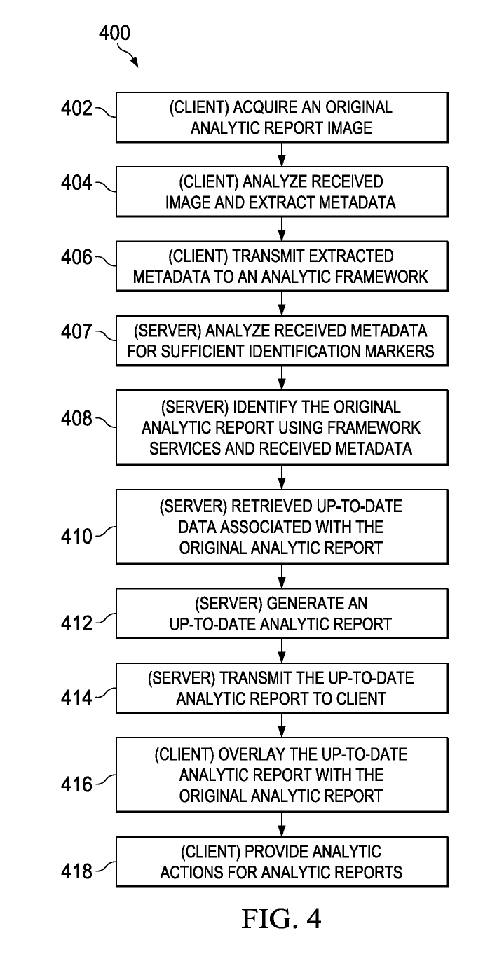

FIG. 4 is a flow chart illustrating a method 400 for providing real-time analytic report analysis and data retrieval. For clarity of presentation, the description that follows generally describes method 400 in the context of FIGS. 1, 2A, 2b, 3A, and 3B (described below). However, it will be understood that method 400 may be performed, for example, by any other suitable system, environment, software, and hardware, or a combination of systems, environments, software, and hardware as appropriate. In some implementations, various steps of method 400 can be run in parallel, in combination, in loops, or in any order.

At 402, an original analytic report image is acquired. The image is typically acquired in electronic/digital format allowing processing by software visual analysis algorithms. In some implementations, the original analytic report image is acquired by a client. The original analytic report image can be acquired by using, for example, one or more client-device cameras, graphical user interface (GUI) “screenshot” functionality, a file download/upload/transfer process, and/or any other suitable functionality.

At 404, the original analytic report image is analyzed and metadata related to the image is extracted. In some implementations, the image can be analyzed and the metadata can be extracted by one or more client applications and/or add-on(s) on a client. The image can be analyzed, for example, by applying any suitable image analysis and/or recognition algorithms through add-on provided functionality, built-in functionality, or any other available functionality associated with the client. For example, optical character recognition (OCR) techniques can be applied for identifying parameters (e.g., title, axis names, legend, values, labels, time and date, version, etc.) of the analytic report image. Graphical pattern recognition algorithms can also be applied to identify the report visualization type (e.g. bar chart, pie chart, etc.).

In some instances, one or more machine-readable representations of data (e.g., a QR code, a bar code or other digital code, a unique identifier, text, symbol, or image) can encode metadata and be embedded in the analytic report. The client can read, decode, or otherwise extract the metadata from the embedded machine-readable representations, for example, by optical analysis software executing on the client.

In some implementations, additional or different techniques can be performed by a server/analytic framework to analyze the analytic report image and to extract metadata related to the analytic report and/or the source application(s)/data used to generate the analytic report. In some implementations, the client can perform some processing of the analytic report image while leaving other processing for the server/analytic framework. In other implementations, the analytic report image can be passed to the server/analytic framework to perform all of the image processing.

At 406, the extracted metadata is transmitted to an analytic framework. In some implementations, the extracted metadata can include data associated with a QR code, barcode, and the like. In some implementations, the acquired analytic report image or a portion of the acquired analytic report image is transmitted together with the extracted metadata to the framework. In this case, some or all image processing and/or metadata extraction can be performed by the analytic framework. In some instances, the analytic framework can perform image processing to verify accuracy of received metadata, for historical purposes, and/or supplement/correct missing metadata. Analytic framework image processing can occur, for instance, when a particular client is missing an add-on or some functionality necessary to extract metadata associated with an analytic report image. In some implementations, the image or a portion of the image is transmitted to the analytic framework for image processing due to security issues, insufficient client processing ability (hardware/software), and/or other suitable reason.

In some implementations, whether to transmit the metadata/identifier of the metadata, the image/a portion of the image, or any combination depends on a capacity and/or connection status of the network connecting the client and the analytic framework/server. Other factors used to determine where image processing/metadata extraction functions will occur can also include processing ability of client/server (e.g., installed applications, processor type, etc.).

At 407, received metadata is analyzed for sufficient identification markers. For example, the analytic framework can analyze whether the received metadata is sufficient for identifying the analytic report/source data used to generate the analytic report. In some instances, the received metadata is determined to be incomplete, in error, and/or otherwise insufficient to identify an analytic report, the framework may send a request back to the client for more information (e.g., a request for more/detailed metadata, a request for the image/a portion of the image of the analytic report, a request for obtaining another image of the analytic report, or similar), or the analytic framework may perform image analysis and metadata extraction itself. In this instance, the analytic framework can execute similar and/or additional techniques/applications possibly not available on the client to analyze the analytic report image to extract necessary metadata.

At 408, the original analytic report is identified using the framework service and the received metadata. The analytic report may be identified by framework services by executing a particular matching algorithm based on metadata, identifier(s), and/or any other identification marker(s). Matching can be as close as possible, or based on certain rules. In some implementations, user input may be required for identifying the analytic report (e.g., for confirmation of an identified analytic report, for resolving ambiguity if more than one report is found matching, etc.). In some aspects of implementations, the user input may be prompted and received by a dialog box presented on GUI 142 of the client 140.

In some implementations, the analytic report can be searched for in the analytic framework data in a local server/business intelligence (BI) system and/or or other servers/systems. In some other implementations, an analytic report can be made up of data/applications from multiple servers/BI systems. The metadata associated with such an analytic report may provide information about the data/applications from the multiple servers/BI systems and how to access data associated with the analytic report. In some instances, if no matching analytic report is found, the framework may throw an error exception or provide a suitable notification to the client and/or other component of the EDCS. In some implementations, the framework may provide reasons for failing to identify a matching analytic report, a recommendation on how to check, modify, refine, or otherwise mange the image, the metadata, and/or the original analytic report to hopefully improve the ability to identify a matching analytic report

At 410, up-to-date data associated with the analytic report is retrieved. The up-to-date data can be retrieved, for example, using analytic framework services based on the identified analytic report and/or the extracted metadata, identifier(s), and/or marker(s). In some instance, the up-to-date data may be retrieved based on a link, an address, an index, a database, and/or any other data structure that cross-references the data with the identified analytic report. In some implementations, the up-to-date data can be retrieved from the analytic framework data in a single server/BI system or from multiple databases/servers/BI systems as necessary.

In some implementations, the up-to-date data can refer to data that is updated up to a latest update time instance. For example, if data associated with the original analytic report is updated weekly, a latest update time instance may be the original analytic report data (if less than a week) or a new set of data associated with the latest update time instance (if over a week). In some other implementations, the up-to-date data may refer to data that is updated a particular time. The particular time can be specified by an indicator in the metadata, based on which the up-to-date data at the particular time can be identified and retrieved. The particular time can be any suitable time instance that is before or after the time that the original analytic report is generated. Based on the data at the particular time instance, a corresponding analytic report can be generated and be compared with the original analytic report such that a change of the data from the time that original analytic report is generated to the particular time can be observed. In some instances, a message can be provided to a user to inform that updated data is not available and/or when updated data will be available.

In some implementations, retrieval of the up-to-date data can be performed only if a successful authentication is provided. For example, the analytic framework may determine whether the client has the authority to access the data/application that used to generate the analytic report, ask for authentication credentials, etc. If insufficient authentication is provided, the framework may throw an error exception and decline the request for the data retrieval.

At 412, an up-to-date analytic report is generated. The up-to-date analytic report can be generated based on the up-to-date data retrieved at 410 and can reflect up-to-date information particular to the underlying data. In some implementations, the updated analytic report can be generated using additional data, including additional data identified by the metadata, the data source, etc. The up-to-date analytic report can be generated according to the same visualization type (e.g. bar chart, pie chart, etc.) as the original analytic report or in an updated/different visualization type. The visualization type can also be determined from the metadata, the data source, etc. In some implementations, the visualization type can be determined by a user seeking an updated report.

In some implementations, the up-to-date analytic report can be generated by a server application and/or calls made through the add-on associated with the server/BI systems. In some implementations, the up-to date analytic report may be generated by applications and/or add-on(s) associated with multiple server/BI systems.

In some implementations, metadata associated with the up-to-date analytic report can also be identified and stored for subsequent. In some implementations, a machine-readable representation of metadata particular to the up-to-date analytic report can be generated and embedded in the up-to-date analytic report. The framework can update the metadata database or dictionary to properly include the metadata such that the up-to-date analytic report can be later searched/identified. The framework may further decide whether to save, delete, modify, or otherwise manage the original/up-to-date analytic report and/or the original/up-to-date data used to generate the analytic reports at the server(s)/BI system(s), and perform any necessary operations based on the decision.

At 414, the up-to-date analytic report is transmitted to the client. In some implementations, the underlying up-to-date data (or a portion of the up-to-date data) can be transmitted together with the up-to-date analytic report to the client along with client usage instructions. In some other implementations, only the up-to-date data (or a portion of the up-to-date data) is transmitted to the client. In these instances, the client can generate the up-to-date analytic report (instead of at 412) or a portion of the up-to-date analytic report based on the received up-to-date data and/or instructions provided by the analytic framework.

At 416, the up-to-date analytic report is overlaid with the original analytic report and presented at the client. Any other suitable display mode (a single report mode, a side-by-side mode, etc.) can also be selected to present the up-to-date analytic report and the original analytic report. In some implementations, more than two analytic reports can be displayed simultaneously. In some instances, multiple analytic reports can be generated, updated, and/or displayed over a certain amount of time such that changes or evolution of data can be observed. Operations similar to the operations described above with respect to FIGS. 2A-2B and 3A-3B, or any additional operation for configuring the display of the analytic reports can be performed.

At 418, analytic actions for the original and/or the up-to-date analytic reports are provided. Analytic actions can include the ability to perform a comparison, drill down into data of either report, scope changes, or any other suitable operations. In some instances, functionality to automatically calculate, analyze, display, and/or highlight differences between the original analytic report and the up-to-date analytic report(s) can be provided. In some implementations, some of the analytic actions can be performed wholly on the client side. In some other implementations, some of the actions may require more data/processing from the framework and/or one or more servers/BI systems. In this case, the client can reach out to the analytic framework and/or one or more servers/BI systems for processing and/or more data. In some implementations, the client can work in conjunction with the analytic framework and/or one or more servers/BI systems to provide advanced analysis action based on the data and/or the analytic reports.

In some implementations, the method 400 can include further interactions between the client and the analytic framework. For example, there may be one or more decisional processing steps executed before, during, or after one or more steps of the method 400. In some implementations, there may be default processing/execution corresponding to each of the steps and the method 400 can be performed following the default settings. In some implementations, the method 400 may require user input to step to a next processing/execution step. For example, the client/server may need the user's selection, confirmation, or any other configuration during the process. In such cases, a pop-up window, a dialog box, an error exception, or any other interface can be presented, for example, on user interface of the client. User inputs can also be received from user interfaces and/or communicated to the client or analytic framework. The client and the analytic framework, and/or any other suitable component in the system can collaborate in providing real-time analytic report analysis and data retrieval service.

FIGS. 1, 2A-2B, 3A-3B, and 4, illustrate and describe various aspects of computer-implemented methods, computer-readable media, and computer systems providing an integrated development environment for client/server environments. While the disclosure discusses the processes in terms of business applications, as will be apparent to one of skill in the art, the described computer-implemented methods, computer-readable media, and computer systems can also be applied to any type of application software consistent with this disclosure. The present disclosure is not intended to be limited to the described and/or illustrated implementations related to business applications, but is to be accorded the widest scope consistent with the principles and features disclosed herein.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDFLOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
receiving extracted metadata associated with a first analytic report;
identifying the first analytic report using the received metadata;
retrieving updated data used to generate the first analytic report;
generating a second analytic report, where the second analytic report is an updated version of the first analytic report and uses the updated data; and
transmitting the second analytic report.

2. The method of claim 1, further comprising acquiring an image of the first analytic report.

3. The method of claim 2, wherein the first analytic report image is received with the extracted metadata.

4. The method of claim 1, further comprising analyzing the received metadata for sufficient analytic report identification markers.

5. The method of claim 1, wherein the metadata is extracted from at least one of a machine-readable representation of data, a QR code, a bar code, a unique identifier, text, symbol, or image.

6. The method of claim 1, further comprising overlaying the second analytic report and the first analytic report to provide a comparison of report associated data.

7. The method of claim 1, further comprising providing analytic actions associated with the first analytic report or the second analytic report.

8. A non-transitory, computer-readable medium storing computer-readable instructions executable by a computer to:
receive extracted metadata associated with a first analytic report;
identify the first analytic report using the received metadata;
retrieve updated data used to generate the first analytic report;
generate a second analytic report, where the second analytic report is an updated version of the first analytic report and uses the updated data; and
transmit the second analytic report.

9. The medium of claim 8, further comprising instructions to acquire an image of the first analytic report.

10. The medium of claim 9, wherein the first analytic report image is received with the extracted metadata.

11. The medium of claim 8, further comprising instructions to analyze the received metadata for sufficient analytic report identification markers.

12. The medium of claim 8, wherein the metadata is extracted from at least one of a machine-readable representation of data, a QR code, a bar code, a unique identifier, text, symbol, or image.

13. The medium of claim 8, further comprising instructions to overlay the second analytic report and the first analytic report to provide a comparison of report associated data.

14. The medium of claim 8, further comprising instructions to provide analytic actions associated with the first analytic report or the second analytic report.

15. A system, comprising:
a memory configured to contain extracted metadata;
at least one computer interoperably coupled with the memory and configured to:
receive the extracted metadata associated with a first analytic report;
identify the first analytic report using the received metadata;
retrieve updated data used to generate the first analytic report;
generate a second analytic report, where the second analytic report is an updated version of the first analytic report and uses the updated data; and
transmit the second analytic report.

16. The system of claim 15, further configured to acquire an image of the first analytic report.

17. The system of claim 16, wherein the first analytic report image is received with the extracted metadata.

18. The system of claim 15, further configured to analyze the received metadata for sufficient analytic report identification markers.

19. The system of claim 15, wherein the metadata is extracted from at least one of a machine-readable representation of data, a QR code, a bar code, a unique identifier, text, symbol, or image.

20. The system of claim 15, further configured to overlay the second analytic report and the first analytic report to provide a comparison of report associated data.

21. The system of claim 15, further configured to provide analytic actions associated with the first analytic report or the second analytic report.
